(19) United States
(12) Patent Application Publication
(10) Pub. No.: US 2018/0152470 A1
(43) Pub. Date: May 31, 2018

(54) METHOD OF IMPROVING NETWORK SECURITY BY LEARNING FROM ATTACKERS FOR DETECTING NETWORK SYSTEM'S WEAKNESS

(71) Applicant: Lixin LU, (US)

(72) Inventor: Lixin LU, San Jose (US)

(21) Appl. No.: 15/363,020

(22) Filed: Nov. 29, 2016

(51) Int. Cl. H04L 29/06

(52) U.S. Cl. CPC H04L 63/1433; H04L 63/1425

(57) ABSTRACT

Being targeted by an attacker is unfortunate and being actually attacked is even worse. When this happens, it indicates there must be a weakness or vulnerability existing in a network that the attacker knows about but a user is unaware of or does not pay attention before. The present invention discloses ideas and methods to find out the weakness, that the attacker has discovered and/or aimed at, from all different traces or evidences or signals left by the attacker at different places during reconnaissance or actually attacking cycle. Furthermore, it decomposes the algorithm used in attack's reconnaissance and performance, and uses the decomposed algorithm to fire-drill-test other systems to see if the same or similar weaknesses exist in other places. Finally, it produces actionable instructions for a user to seal and to fix the identified weakness right away for stopping an attack and protecting the network and connected devices and systems.

### BACKGROUND OF THE INVENTION

### 1. Field of the Invention

The present invention relates to computer and network security, more specifically to forensic analysis of attacking processes and their evidences for improving network security. It is also related to computer malware and sandbox, attack's kill chain, network sniffer, and endpoint snapshot.

### 2. Description of the Related Art

As refereed herein, a kill chain means an attacking process. It consists multiple steps, from a reconnaissance to an action on an objective (AOO). Each of such steps fulfills special needs. For example, a reconnaissance, step 1, is to find weakness to lock down a target. Step 2 is a weaponization: writing shell codes to exploit the weakness or vulnerability found. Step 3 is a delivery: spreading the shell codes to targets. Step 4 is an exploitation: executing the shell codes. Step 5 is installation: installing back door Trojan. Step 6 is for command and control (C&C): harvesting stolen data and/or launching more attacks. Step 7 is for actions on objectives: completing its attacking goal.

As refereed herein, a sandbox is designed for a malware file object or an URL object to execute within an isolated environment to produce behavior log for malicious analysis. In the above kill chain, at step 5, if a Trojan file is captured, it could be sent to a sandbox for behavior analysis.

As refereed herein, a network sniffer is designed and implemented for network packet capture. In the above kill chain, at step 1 as a reconnaissance, step 3 as a delivery, and step 6 as connecting to command and control (C&C), an attack leaves some traces and evidences in network packets. Those traces and evidences are good sources for forensic analysis of attacks.

As refereed herein, a malware is a harmful program designed and implemented by an attacker to infect and to take over control of a victim's computer for malicious purposes. In the above mentioned kill chain, step 2, 4, and 5 are related to malwares.

As refereed herein, a pen test (PT) is a method of testing a computer system to detect its vulnerabilities based on predefined rules.

A computer network, typically consists of multiple computing devices, such as desktop computers, laptop computers, server computers, physical computers, virtual computers, handholds devices such as smart phones, and devices of Internet Of Things (IOT), linked together through switches, such as physical switches or virtual switches, one or multiple routers, physical or virtual routines, implemented in hardware or software, one or multiple firewalls, implemented in hardware or software, and then maybe linked to Internet.

Programs running on computers and devices in a network typically are:

operating systems such as Windows OS, Linux OS, routing OS, and firewall OS; and

applications including server applications, such as Microsoft web server, Apache web server, SQL, and SAS; and endpoints software, such as word processors, internet chatting software, email clients, and internet browsers.

Attackers herein are typically computer criminals who break into the computer network system without users' authorization, steal valuable data/information from the system, and cause damage to the system or to users, for malicious purposes.

A weakness means a system security vulnerability that can be used as an entry for an attacker to break into a network system. Reasons that a weakness exists in a network system include a system design flaw, a hardware or software implementation bug, outdated hardware or software, infection by a malware or a planted backdoor by a previous attacker, an access token for authentication being stolen, a vulnerable or stolen password, etc.

There are many products and solutions that can detect some weaknesses in network system, such as anti-virus software (AVS), intrusion detection software (IDS), intrusion prevention software (IPS), firewall, sandbox (for analyzing suspicious file objects or URL based on execution behavior), and pen tester (PT).

Each product or solution focuses on a particular stage of a kill chain to address attacking problems. Usually, they produce tons of alert messages overwhelming and drowning users. Users face tons of alerts daily and cannot figure the messages out easily what and where shall get fixed first.

There is a need for a product or a solution that focuses on finding a particular weakness currently discovered and aimed at by an attacker, in order to provide a user with a workable instruction as what and where with the highest priority a weakness that needs to be fixed right away. If the user can keep it up and always fixes the weakness or vulnerability at least at the time the attacker just discovered or aimed at or even one step ahead of the attacker, it is possible to defeat attacks.

### BRIEF SUMMARY OF THE PRESENT INVENTION

The present invention discloses methods of discovering a weakness while an attacker is aiming at by analyzing attacker's early reconnaissance and traces or evidences at different stages of an attack's kill chain. At least one of the methods in the present invention is to keep a user always one step ahead of the attacker, knowing where and what the weakness is being discovered and aimed at by the attacker. While the attacker is locking down a target for attacking, a user, meantime, is able to lock down the highest priority to fix and seal a vulnerability that is targeted before an attack is launched.

Sometimes, at a step of a kill chain, there are only a few or limited traces or evidences and they could also be scattered all over different places, such as network traffic logs, malware sandbox behavior analysis logs, and endpoint system snapshots, while a single product or a solution usually only collects and looks into the traces or evidences in an isolated way and thus could fail to detect an attack. This invention discloses an automated method and system that collects the scattered traces or evidences with a maximized extend. Even though such a trace or an evidence is not a direct or obvious indication of an attack, once all of such traces or evidences are put together, an attack signal or indication becomes clearer. The method disclosed here is to put all evidences collected from all different places and different stages of the kill chain together for a comprehensive analysis. This comprehensive analysis detects where and what kind of weakness is being utilized by the attacker. It further decomposes the algorithm implemented in performing the attack or reconnaissance, and use it to test other computer devices/system for finding out if such a weakness exists in other places for proactively finding out similar weakness in other places in the network. When the weakness is detected, the system in the present invention produces instructions as how to fix it and seal the vulnerability.

### BRIEF DESCRIPTION OF THE FIGURES

The following description with reference to exemplary and illustration drawings of the present invention will be further described in detail, but the present illustration is not intended to limit the embodiment of the present invention, any similar structure of the present invention and similar changes should be included in the scope of the present invention.

Below in conjunction with illustration with FIGS. 1-7, the present invention will be described in detail as follows.

FIG. 1 is an illustration of a computer network system in which the present invention has applicability.

FIG. 2 is an attack's kill chain diagram in which the present invention has applicability.

FIG. 3 is a network diagram having a network sniffer in which the present invention has applicability.

FIG. 4 is a sandbox diagram in which the present invention has applicability.

FIG. 5 is a diagram illustrating endpoint snapshot in which the present invention has applicability.

FIG. 6 is a flow diagram illustrating a preferred embodiment of the present invention.

FIG. 7 is a block diagram illustrating a method of analyzing attack traces or evidences in the present invention.

### DETAILED DESCRIPTION OF THE INVENTION

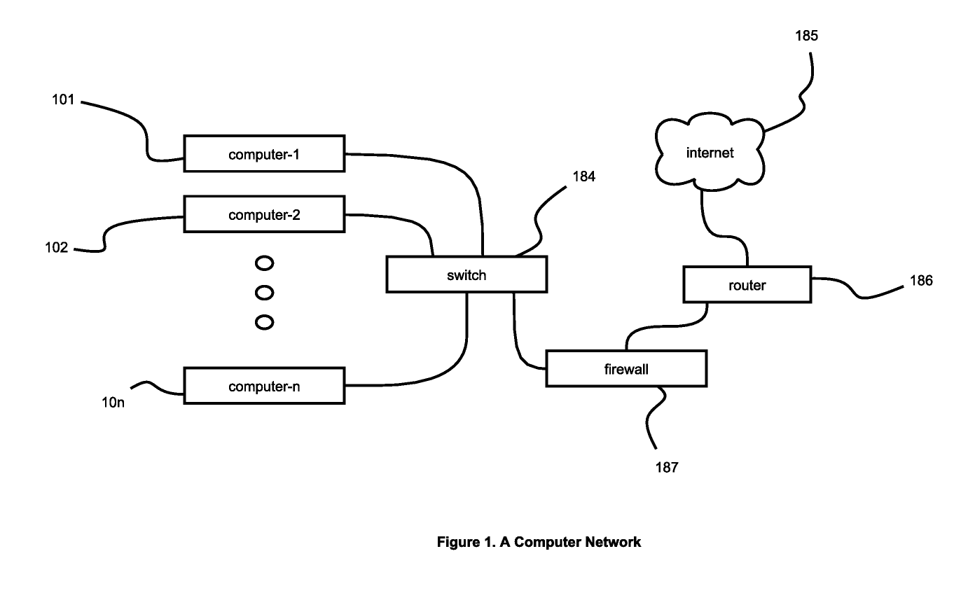

FIG. 1 illustrates an environment in which the present invention has applicability. A plurality of computers are interconnected in a closed proprietary network, and through a router the network is accessible via Internet. As illustrated in FIG. 1, there are computer devices 101, 102, and 10n, such as desktop computer, sever computer, or handhold computer device or IOT devices, or virtual computers (VM). They are linked through the switch 184, that can be a physical switch or a virtual switch or a wired connection switch or a wireless switch. The link to the switch 184 can be physical wired link or wireless link. This switch 184 linked with a firewall 187, it can be hardware firewall or software firewall, or virtual firewall. After firewall 187, the network goes through router(s) 186, it can be hardware router(s) or software routine(s) or virtual routine(s). It then connects to the Internet 185.

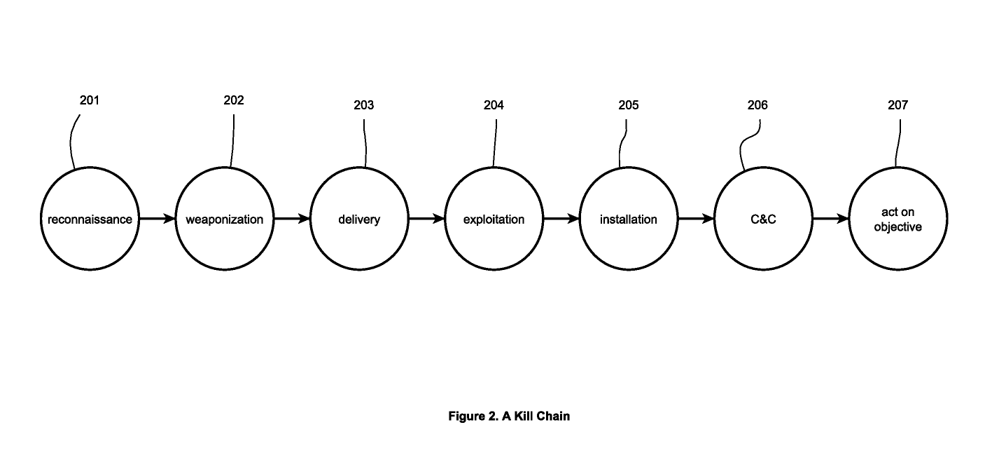

FIG. 2 illustrates a typical attack, especially an advanced persistent threat (APT), a kill chain.

In FIG. 2, symbol 201 represents a reconnaissance, finding weakness to lock down target. There are many types of weaknesses, such as a network protocol vulnerabilities, operating system's vulnerabilities, application vulnerabilities, infections by malwares or planted backdoors. This step could be lengthy and various reconnaissance tools could be used. It leaves some traces or evidences along with a reconnaissance process. Those traces or evidences, event that might be scattered and tiny, are good sources for collection and analysis for detecting what the attacker is getting. They could lead to discover what weakness the attacker is discovering or has discovered.

In FIG. 2, symbol 202 represents a weaponization that an attacker writes a shell code to exploit the weakness found by the attacker. The shell code is specially crafted by the attacker. The shell code could be a completed program file or a small script of codes that runs inside other live processes through code injection. The shell code utilizes system or application or network vulnerability and can hide from existing security products or solutions, such as IDS/IPS, firewall, and antivirus software. It usually also hides from a sandbox analyzer.

In FIG. 2, symbol 203 represents a delivery, spreading the shell code to targets. It can be delivered through network protocol vulnerabilities, through email attachments or web downloading, or simply over network file sharing, etc.

In FIG. 2, symbol 204 represents an exploitation, executing the shell code. Sometimes, a shell code execution doesn't trig events, such as a new process creation and a network port opening.

In FIG. 2, symbol 205 represents an installation, installing backdoor Trojan. Most of succeeded attacks leave some backdoors for later on further exploitation and this makes the infected endpoint weaker.

In FIG. 2, symbol 206 represents a command-and-control (C&C), harvesting stolen data and/or launching attacks. An attacker, at this stage, has successfully broken into the victim's network system, deployed one or more backdoor(s), and now communicates with its command and control center for further instructions.

In FIG. 2, symbol 207 represents an action on objectives, completing its attacking goal. The goal could be stealing important data from victim's network system or simply damaging a system.

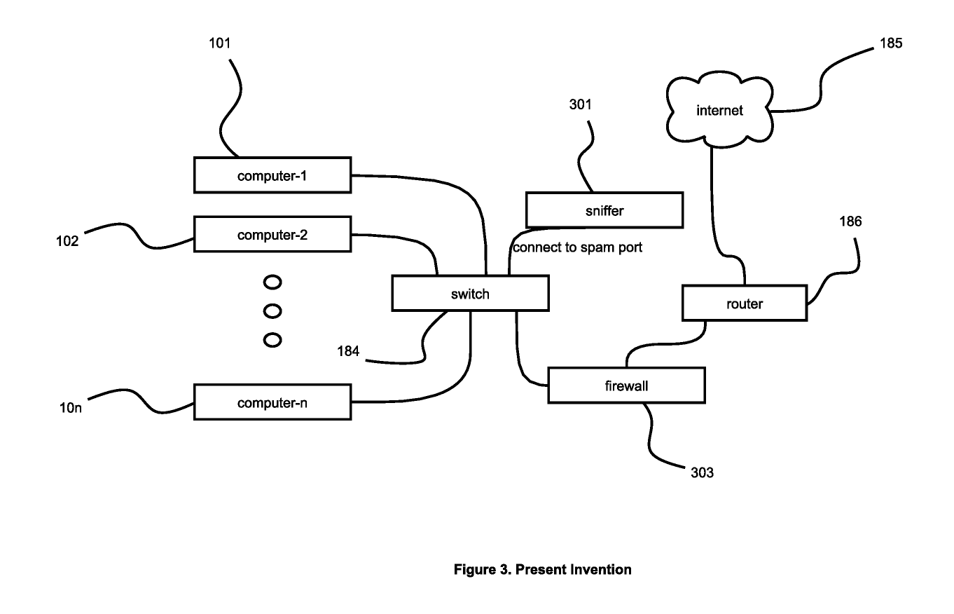

FIG. 3 illustrates a typical sample of network, similar to FIG. 1, but having a sniffer 301 installed. The method in the present invention applies a network sniffer 301 for capturing network packets and for collecting attacking traces or evidences. The network sniffer 301 can be connected to a physical switch but it also can be connected to a virtual switch. The sniffer may be implemented as software or hardware or a combination of software and hardware. One of the steps of the method in the present invention is to use a network sniffer 301 for collecting traces or evidences on the kill chain's step 1, reconnaissance 201, step 3 delivery 203, step 6 C&C 206, and step 7 AOO 207 where the attacker communicates with command and control (C&C) 206 center or ship back the stolen data. Though at the kill chain's step 7 AOO 207 it is too late to fight with this attack, analyzing and understanding it is still important for learning how the attack went through, what and where the weakness is, that the attack took advantage of, and how to fix and to seal the weakness.

A weakness could also exist in network communication itself, in network contents that are delivered to applications, or in a network protocol through protocol vulnerabilities. The method in the present invention uses one or more network sniffer(s) 301 for collecting all relevant network packets and sends to them to an analysis center for comprehensive triage.

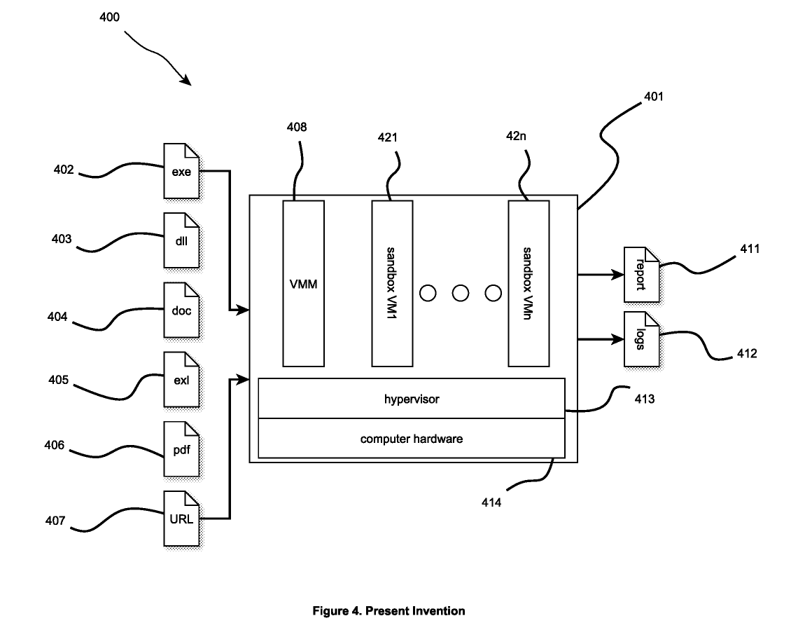

FIG. 4 illustrates the method in the present invention using typical malware sandboxes 421 and 42n, letting malware object execute in an isolated environment, such as VM 421 and 42n, to produce behavior log and then analyze those behavior log for detecting a malware. Symbols 401 to 407 represent various types of objects including one or more of the following: exe, dll, doc, excel, pdf or flash file, as well as URL object, that are sent into sandboxes 421-42n for analysis. The method in the present invention also uses a sandbox for detecting and identifying a Trojan through its execution behavior.

In FIG. 4, a sandbox 400 is a computer device that has a hardware 414 and atop the hardware 414 there is a layer of hypervisor 413. Atop the hypervisor 413, it runs Virtual Machine Manager (VMM) 408 and through the management of VMM 408, it runs multiple virtual machines, from 408 to 421. Each VM provides an isolated execution environment, it has its own OS, such as Windows OS, applications, and web browser(s). When suspicious objects arrived at VMM, it forwards it to a proper predefined VM for execution. Once the execution is completed, the behavior log 412, is produced and forwarded to analyzer for analysis and producing report 411. Sandbox's log and report are used for finding out where and what the weakness aimed by the attacker is though sometimes, a sandbox cannot produce enough log 412 and report 411, due to that the sandbox OS or application environment doesn't meet the needs for malware object to execute, or particularly the malware object is equipped with sandbox evasion techniques.

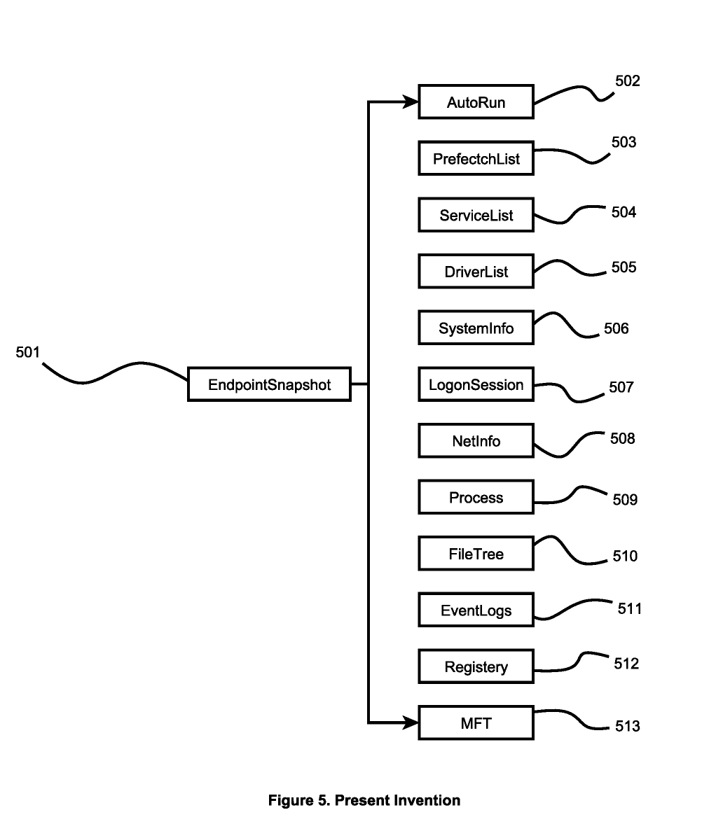

FIG. 5 illustrates a typical endpoint snapshot diagram, wherein symbol 501 represents an endpoint snapshot taken from an endpoint, meaning endpoint computer system, either computer server or workstation, such as desktop computer, or laptop computer, or handhold devices, or IOT devices. The endpoint snapshot includes, but not limited to, list from symbol 502 to symbol 513.

In FIG. 5, symbol 502 represents a set of auto-run information (AutoRun), meaning everything that makes a program automatically execute on computer reboot.

In FIG. 5, symbol 503 represents a pre-fetch list (PrefetchList), it records what program has been launched before. It indicates if a downloaded program is launched or not.

In FIG. 5, symbol 504 represents a service list (ServiceList). It lists all system service programs that possibly run in the system.

In FIG. 5, symbol 505 represents a driver list (DriverList). It lists all device drivers the system has. Note, drivers are system level programs that have ring-O privilege. They are often targeted by attackers to deeply hide their malicious code or access system resources where no ring-3 program is allowed.

In FIG. 5, symbol 506 represents a set of system information (System Info). It is about the entire computer hardware and software information, including environment variables, system configurations, resources, etc.

In FIG. 5, symbol 507 represents a set of logon session information (LoganSession), that lists all currently open session, including local logon sessions and remote logon sessions. If a user logged onto the system remotely via a network, this logon activity will show up in this list.

In FIG. 5, symbol 508 represents a set of network information (NetInfo), including local routing table(s), host name(s), currently opened port(s), connection(s), socket(s), and a record of how connections are made and their owner process names. The method in the present invention uses NetInfo for analyzing and detecting malicious network activities and connections.

In FIG. 5, symbol 509 represents a set of process information (ProcessInfo), listing all currently running processes, including names, publishers, file paths, image sizes, digit signatures, version numbers, loaded modules, opened handles, etc. The method in the present invention uses ProcessInfo for identifying if the system is currently infected by a malware or is hacked by an attacker.

In FIG. 5, symbol 510 represents a file tree (FileTree), listing all files and directories in a system. An attacker once breaks into the system, a backdoor such as a Trojan is planted for keeping an access for further exploiting. In this case, a Trojan file will be created onto the system and show up in this file tree list. The method in the present invention uses FileTree for identifying if the system is attacked with such activities by an attacker.

In FIG. 5, symbol 511 represents an event log (EvenLog), listing all various kinds of events including security events, such as Windows security events, security software events, and application events. The method in the present invention uses EvenLog for collecting attack indicators as attacking is undertaking.

In FIG. 5, symbol 512 represents a system registry (SR) that lists all configuration changes and where the SR currently points to. A malware usually leverages a system registry to gain activation after a reboot or gets automatically launched along with system services or other popular programs. The method in the present invention uses the SR for identifying if the system is attacked with such activities by an attacker.

In FIG. 5, symbol 513 represents a master file table (MFT). A sophisticated malware attack infects an MFT in order to gain activation after a system reboots. It is also a vulnerable place for an attacker to hide a malware. The method in the present invention uses the MFT for identifying if the system is attacked with such activities by an attacker.

The method in the present invention collects one or more endpoint snapshot(s) for threat analysis and investigation. The method in the present invention also combines reports and logs from both sandbox(es) and endpoint snapshot(s) in a comprehensive analysis for identifying a malware or an attack.

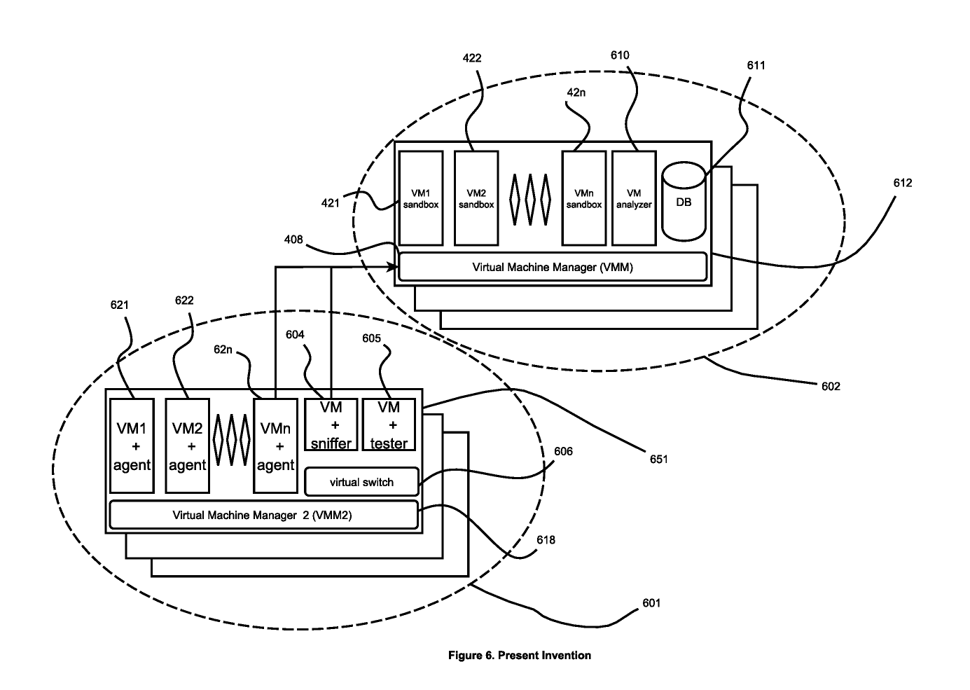

FIG. 6 illustrates a preferred embodiment of the present invention.

In FIG. 6, symbol 601 represents a cluster of cloud computers, in which, it runs one or more virtual machine(s) (VM(s)) and each VM hosts an application server. Symbols 408 and 618 represent virtual machine managers. They manages virtual switch(s) (FIG. 6-4). Symbol 606 represents one or more virtual switch(s) that facilitate(s) communications between and among those VMs as well as Internet. Symbols 621-62n represent VMs that are used to run various server applications. Each VM has a proactive agent installed to monitor abnormal activities of those applications. Once it detects an abnormal behavior, it takes a snapshot and sends it to a triaging center 602 for comprehensive analysis. If an attack is identified by the triaging center 602, the triaging center 601 decomposes attacking algorithms and send them back to a tester VM 605 to perform a fire-drill test on all other VMs. Symbol 604 represent a VM that runs one or more sniffer(s), monitoring and capturing packets and logging the relevant information if an attack is suspected happening.

Symbol 602 represents a triaging center that performs a comprehensive analysis including analyzing network logs and endpoint snapshots. If a file object or URL object is received, it also fires up a sandbox to perform behavior analysis. The interface for file, network records and snapshot submission is through restful APIs. Symbols 401-40n represent multiple sandbox VMs. Each sandbox can be configured to run various versions of various operating systems including but not limited to Windows OS so that different malware file objects can find right versions of OS to run. Symbol 610 represents a set of triaging analysis VM(s) that performs comprehensive analysis on correlated traces and evidences including but not limited to that in one or more of the following: endpoint snapshots, network traffic records and sandboxes' behavior reports and logs, decomposes attacking algorithms used by an attacker, and then sends a result back to tester VM 605 for fire-drill tests. Symbol 611 represents a database that stores all collected information from the sandboxes, the snapshots, and the network traffic records.

Symbols 621, 622, . . . , and 62n represent VM agent servers for taking snapshot and monitoring event triggers. The same or similar agents installed on these servers can be installed on physical computer servers or workstations for taking snapshot and monitoring event triggers. Symbol 606 represents a set of virtual switches. Alternatively a set of physical switches can be used. Symbol 604 represents a set of virtual machine sniffers. Alternatively sniffers can be implemented and installed on physical computer devices and linked with physical switches.

Symbol 601 represents a threat triaging center implemented in cloud but alternatively it can also be implemented on physical cluster of computers. The interfaces for the agent(s) submitting snapshot and for the sniffer(s) submitting network log are the same as restful APIs.

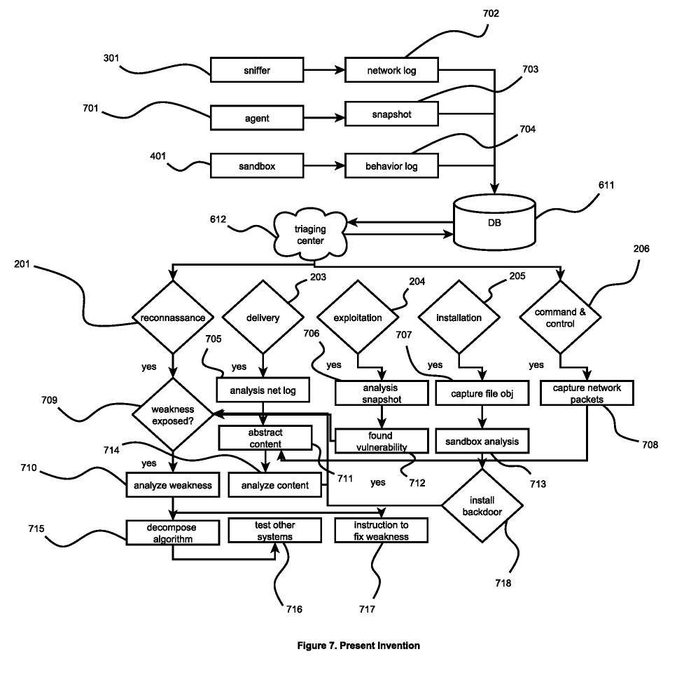

FIG. 7 is a block diagram illustrating the present invention for analyzing traces or evidences collected through sniffer(s), agent(s) 701 and sandbox(es) 401 including comprehensively analyzing them at a triage center 612 and discovering what and where a weakness is, that an attacker has discovered or could target at during next attack. Symbol 301 represent a set of sniffers, that capture network packets 702 and sending them to the database 611. Symbol 701 represents a set of agents that take endpoint snapshots 703 and sends them to the database 611. Symbol 401 represents a set of sandboxes that analyzes malicious program files or URL and sends behavior reports and log files 704 to the database 611.

The triaging center 612 takes collected logs and reports from the database 611 and performs a comprehensive analysis. If it is found that an attack is at an early step reconnaissance 201, the triaging center 612 identifies if any weakness is exposed at a step 709. If the answer is “yes”, the triaging center 612 performs a step 710 to analyze the weakness and then performs a step 715 to decompose the algorithm that is used by the attacker in finding the weakness. Next in a step 716 the triaging center 612 uses the decomposed algorithm to perform test against other systems where the attacker hasn't attacked yet. Meantime, the triaging center 612 also produces actionable instructions for a user to fix the weakness identified at step 717.

The triaging center 612 checks if an attack is at a shell code delivery step 203. If the answer is “yes”, the triaging center 612 analyzes the network content at a step 705 and abstracts a network content at a step 711. Then the triaging center 612 analyzes the abstracted content at a step 714. After this step, the triaging center performs step 709 for checking if any weakness is exposed. If “yes”, the triaging center 612 performs the step 715 to decompose the algorithm that is used by the attacker to deliver the shell code followed by using such a delivery algorithm to perform the step 716 for testing other systems to see if such a delivery by the attacker has succeeded or not. If “yes”, it indicates other systems are also vulnerable to such an attacking algorithm. In parallel, the triaging center 612 performs a step 717 to produce repair instructions for having the weakness fixed.

If collected information indicates an attack is at an exploitation stage 204 of a kill chain, the triaging center 612 performs a step 706 to analyze snapshots and performs a step 712 to confirm a vulnerability. Then the triaging center 612 performs the step 709 for checking if a weakness is exposed. Then the triaging center 612 performs the step 715 to decompose the algorithm as how the exploitation went succeeded by the attacker. And then the triaging center 612 performs the step 716 to test other systems using the attack algorithm for identifying if other systems are also vulnerable to such an exploitation. And in parallel, the triaging center 612 also produces repair instructions by performing the step 717 for repairing the weakness.

If collected information indicates an attack is at an installation stage 205 of a kill chain, the triaging center 612 performs a step 707 to capture installation file object(s) by an agent inside 612 and performs a step 713 to send the file object(s) to one or more sandbox(es) for behavior analysis. Then the triaging center 612 performs a step 718 for identifying if any backdoor is installed. Then the triaging center 612 performs the step 709 for checking what kind of weakness exposed that allows such an installation went succeeded. And then the triaging center 612 performs the step 710 to analyze the weakness and performs the step 715 to decompose the algorithm used by the attacker for figuring out how the backdoor gets installed. Afterwards, the triaging center 612 performs the step 716 to use the decomposed algorithm for testing other systems to see if the same or similar weakness also exists in other systems. Meantime, the triaging center 612 performs the step 717 to produce repair instructions for fixing the weakness.

If collected information indicates an attack is at communication with command and control (C&C) stage 206 of a kill chain, the attack has established a footage and control over a victim's computing device. The triaging center 612 performs a step 708 using one or more network sniffer(s) to capture network packets, performs the step 711 to abstract content from captured network packets, and performs the step 714 to analyze the abstracted content for identifying vulnerabilities that allow the attack succeed to this stage and a content being communicated with the C&C 206. Then the triaging center 612 performs the step 709 to check if a weakness is exposed. If so, the triaging center 612 performs the step 715 to decompose the algorithm as how the exploitation went succeeded by the attacker. And then the triaging center 612 performs the step 716 to test other systems using the attack algorithm for identifying if other systems are also vulnerable to such an exploitation. And in parallel, the triaging center 612 also produces repair instructions by performing the step 717 for repairing the weakness.

1. A method comprising:
a. collecting attack traces or evidences using one or more network sniffer(s);
b. collecting one or more suspicious file object's execution behavior log(s) using one or more sandbox(s);
c. collecting one or more endpoint device's snapshot(s);
d. analyzing results from the above steps for identifying trace(s) or evidence(s) that an attacker leaves behind for discovering a security weakness; and
e. identifying, according to the results from the above steps, where if the security weakness that the attacker is aiming at exists and what it is.

2. The method of claim 1 further comprising decomposing attacking algorithms that the attacker uses for discovering the security weakness and for conducting an attack.

3. The method of claim 2 further comprising, according to attacker's algorithms decomposed, producing testing codes to test other systems for detecting a security weakness that could exist in other places on a network.

4. The method of claim 1 wherein the security weakness is a vulnerability existing in a computer system or network that the attacker is aiming at;

5. The method of claim 1 wherein the trace or evidence is an indicator showing an attack is happening or has happened;

6. The method of claim 1 wherein collecting one or more endpoint device's snapshot(s) comprises collecting a piece of endpoint device's system information from one or more of the following: configurations, security settings, file objects, registries, processes, system level hooks, mutex objects, application level configurations, handles, and modules, that may be used for analyzing attack activities or attack planted backdoor(s).

7. The method of claim 2 wherein the attacking algorithm(s) is/are an implementation of attacking process or tools that are used for discovering a security weakness or for exploiting a security weakness;

8. The method of claim 2 wherein decomposing the attacking algorithm(s) comprises an analytic process to understand the attacking algorithm(s) as how the attacking is implemented and how the attacker decodes the information collected by the attacker for figuring out what the weakness is and where the weakness exists.

9. The method of claim 3 wherein producing testing codes to test other systems for detecting a security weakness that could exist in other places on a network comprises implementing testing codes to test other non-targeted system in order to proactively find such a weakness existed in other systems.

10. The method of claim 1 wherein collecting attack traces or evidences using one or more network sniffer(s) comprises using one or more sniffer(s) in one or more types of hardware, software, and a combination of hardware and software.

11. The method of claim 1 wherein collecting one or more suspicious file objects' execution behavior log(s) using one or more sandbox(s) comprises
a. letting one or more suspicious object(s) execute in one or more isolated environment(s);
b. producing a behavior log from the above step; and
c. analyzing the behavior log for determining if the suspicious object is a malware including but not limited to a Trojan.

12. The method of claim 11 wherein letting one or more suspicious objects execute in one or more isolated environment(s) comprises executing one or more suspicious objects in one or more virtual machine(s) (VM(s)).

13. The method of claim 12 wherein executing one or more suspicious objects in one or more virtual machine(s) (VM(s)) comprises using a virtual machine manager (VMM) in either software or hardware for managing more than one VMs when more than one VMs are used.

14. The method of claim 1 wherein collecting one or more suspicious file object's execution behavior log(s) using one or more sandbox(s) comprising executing one or more of the following types of objects: exe, dll, doc, excel, pdf, flash, and URL.

15. The method of claim 1 wherein collecting one or more endpoint device's snapshot(s) comprises collecting information from one or more files of auto-run (AutoRun) file, pre-fetch list (PrefetchList), server list (ServiceList), driver list (DriverList), system information (SystemInfo), logon session (LoganSession), network information (NetInfo), process information (ProcessInfo), file tree (FileTree), event logs (EventLogs), system registry (SR), and master file table (MFT).
